(19) United States
(12) Patent Application Publication
(10) Pub. No.: US 2026/0225825 A1
(43) Pub. Date: Aug. 6, 2026

(54) APPARATUS FOR THE CONTROLLED MOVEMENT OF CONTAINERS

(71) Applicant: MAKRO LABELLING S.R.L., GOITO (Mantova) (IT)

(72) Inventors: Simone MARCANTONI, Ponti sul Mincio (Mantova) (IT); Davide FORONI, Roverbella (Mantova) (IT); Massimo BECCARI, San Giorgio Bigarello (Mantova) (IT)

(21) Appl. No.: 19/147,871

(22) PCT Filed: Nov. 16, 2023
(86) PCT No.: PCT/IB2023/061608

§ 371 Date: Jul. 14, 2025

(30) Foreign Application Priority Data
Jan. 16, 2023 (IT) 102023000000507

(51) Int. Cl. B65G 47/32; B65B 21/06; B65B 35/24; B65G 17/26; B65G 17/32; B65G 43/08

(52) U.S. Cl. CPC B65G 47/32; B65B 21/06; B65B 35/243; B65G 17/26; B65G 17/326; B65G 43/08; B65G 2201/0244; B65G 2201/0252; B65G 2203/0233; B65G 2203/0241

(57) ABSTRACT

An apparatus for the controlled movement of containers comprising a feed conveyor, configured to feed at least one container to a pick-up region and at least one transfer equipment, configured to pick up the container from the pick-up position and to perform a transfer of the container along a conveying path. In detail, the transfer equipment comprises a first and a second retaining element, which are reciprocally movable along the conveying path to define at least one approached position, which is suitable for grasping therebetween a container, and a distanced position, which is suitable for disengagement from the container; The first and second retaining element, moreover, are mounted and movable on respective independent tracks, and wherein each track is defined by a respective loop conveyor.

The present invention relates to an apparatus for moving containers to be treated.

More in detail, the present invention relates to an apparatus for the controlled movement of containers.

Therefore, the present invention fits in the field of the treatment of containers to perform processes such as labelling, bottling, sterilization, encapsulation and similar treatments. Preferably, the present invention refers to the field of labelling.

The term “containers” means any receptacle adapted to contain a product such as, only by way of example, bottles, cans or jars.

Generally, a machine for moving containers comprises a feed device, such as a conveyor belt, for feeding a plurality of containers arranged in an arbitrary position with respect to each other, and a transfer unit for picking up the fed containers and perform a transfer thereof towards a processing station which can be a rotating carrousel, a linear conveyor or anything else not expressly indicated herein.

Generally, the transfer unit comprises at least one dragging device (e.g. transfer star wheel or auger), configured to engage a respective container and to keep the same in a predetermined position during the transfer.

Generally, moreover, the dragging device is configured to grasp the container and is movable in such a way as to transfer the container.

Disadvantageously, the known dragging devices are compatible with a narrow type of containers, i.e. with containers having sizes within a narrow interval of sizes.

Therefore, in order to be able to work with containers of different sizes and shapes, it is necessary to replace, for example, the star wheel or the auger, depending on the new type of format it is wished to treat.

In this situation, it is an object of the present invention to propose an apparatus for moving containers comprising versatile retaining means, i.e. compatible with containers of varying sizes.

It is also an object of the present invention to propose an apparatus for moving containers that is more efficient in terms of managing containers of different types.

Finally, it is an object of the present invention to propose an apparatus for moving containers capable of interfacing with a machine that operates in an alternating mode, that is, that moves batches of containers, arranging the containers in batches in a predefined reciprocal position according to the working needs of the machine.

The stated technical task and specified objects are substantially achieved by an apparatus for moving containers comprising the technical features disclosed in one or more of the appended claims.

The dependent claims correspond to possible embodiments of the invention.

Further features and advantages of the present invention will become more apparent in the indicative, and therefore non-limiting, description of preferred but non-exclusive embodiments of an apparatus for moving containers.

Such a description will be set out below with reference to the accompanying drawings, which are provided for illustrative and therefore non-limiting purposes, in which:

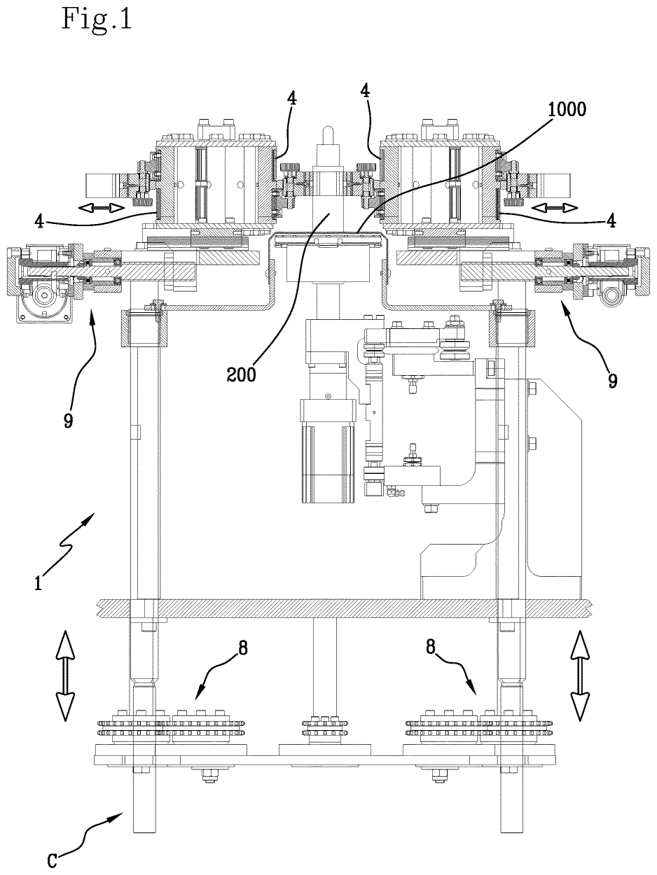

FIG. 1 shows a schematic view of the apparatus for the controlled movement of containers subject-matter of the present invention;

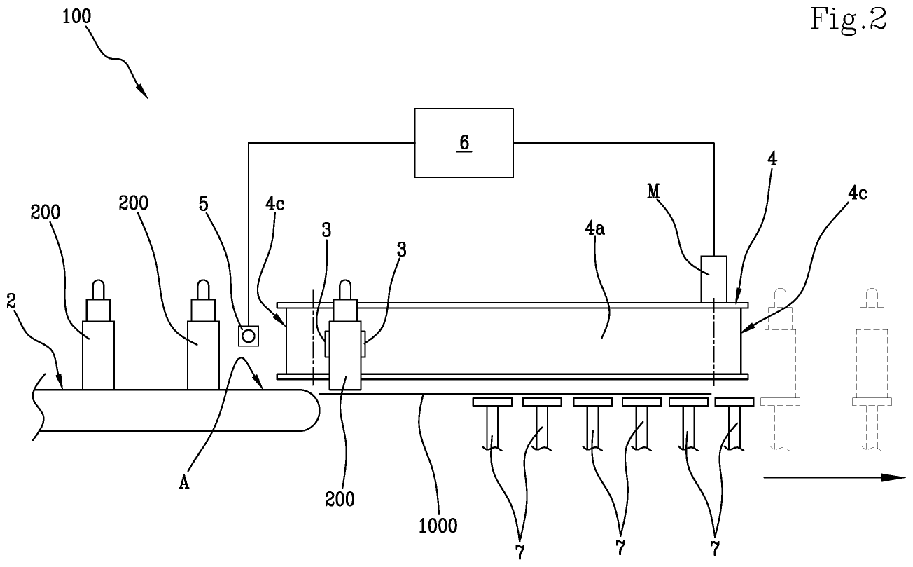

FIG. 2 shows a schematic sectional view of FIG. 1;

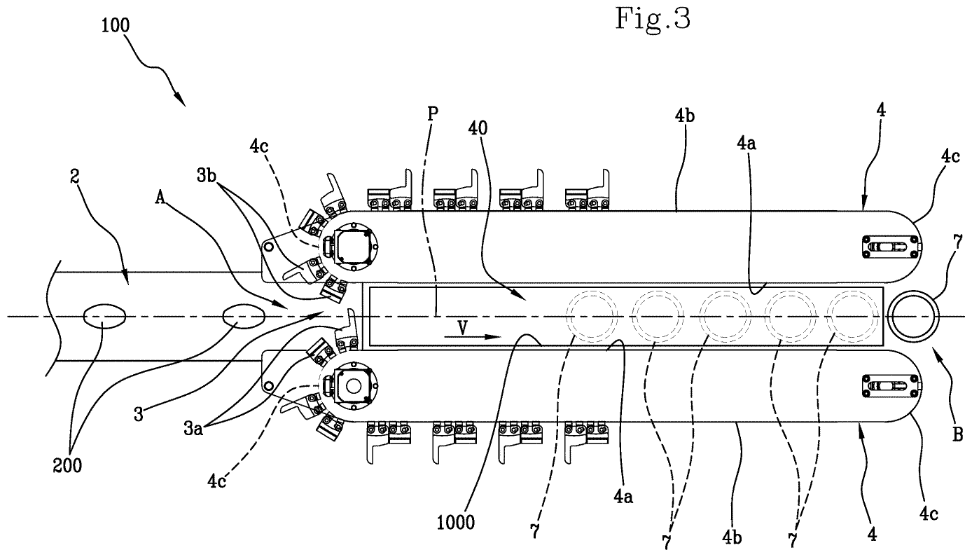

FIGS. 3 to 8 show a schematic top view of the machine in FIG. 1, in different working configurations;

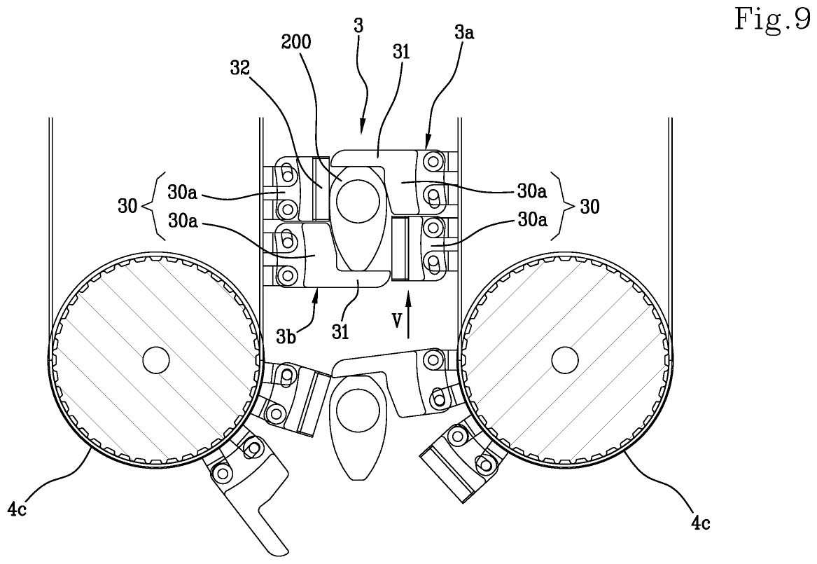

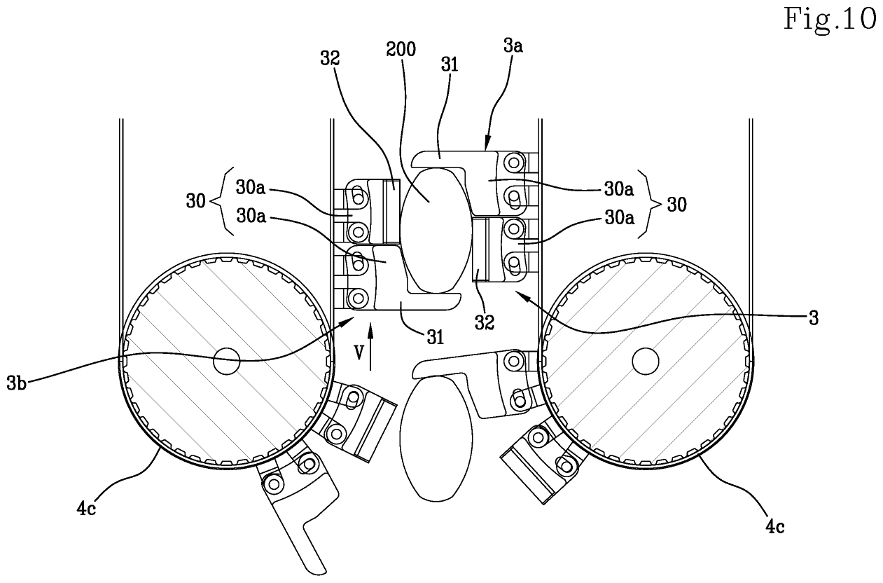

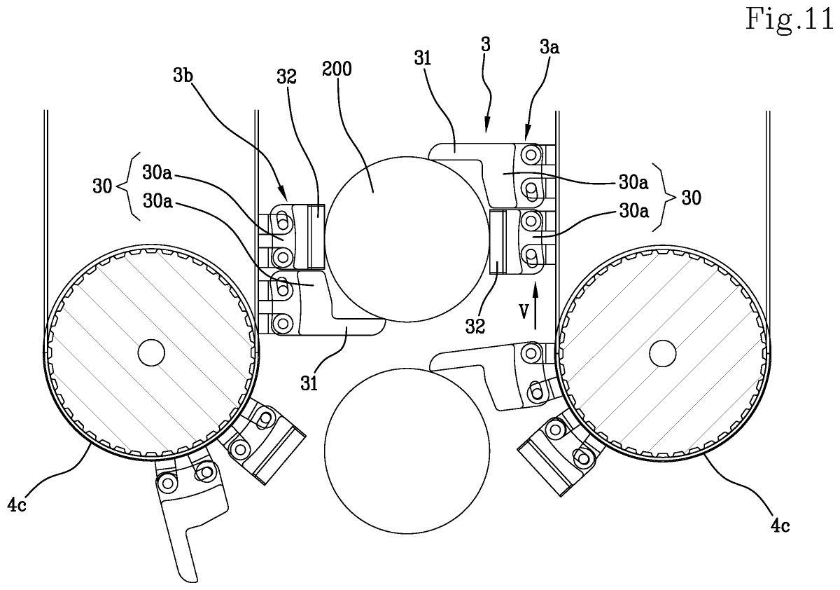

FIGS. 9 to 11 show a schematic top view of a portion of the machine for gripping containers of different shape and size according to the present invention.

The present invention makes available an apparatus 100 for the controlled movement of containers, schematically illustrated in FIG. 1.

The apparatus 100 is configured to perform a controlled transport of containers, in other words, the apparatus 100 is configured to transport containers in a predetermined number and/or at predetermined intervals and/or is configured to arrange the transported containers at predefined positions.

The apparatus 100 comprises a frame 1, preferably with substantially vertical extent.

With reference to FIGS. 2-8, the apparatus 100 comprises a feed conveyor 2, configured to feed at least one container 200 to a pick-up region “A”.

In other words, the feed conveyor 2 is configured to receive a container 200 supportingly and to move it up to the pick-up region “A”.

Preferably, the conveyor 2 is made in the form of a belt conveyor.

Preferably, the feed conveyor 2 is actuated by means of a respective motor not depicted in the attached figures.

The apparatus 100 also comprises at least one transfer equipment 3, configured to pick up the container 200 from the pick-up position “A” and to perform a transfer of the container 200 along a conveying path “P” and in a transfer direction “V”, indicated by means of a respective arrow “V” in the attached figures.

In other words, the transfer equipment 3 is movable at least along the conveying path “P” and at least at the pick-up region “A”.

In more detail, and with reference to FIGS. 9-11, the transfer equipment 3 comprises a first and a second retaining element 3a, 3b, which are reciprocally movable along the conveying path P to define at least one approached position, which is suitable for grasping therebetween a container 200, and a distanced position, which is suitable for disengagement from the container 200 itself;

In FIGS. 9-11, a pair of retaining elements 3a, 3b (arranged upstream with respect to the transfer direction “V”) is depicted in an approached configuration, and a pair of elements 3a, 3b (arranged downstream with respect to the transfer direction “V”) is depicted in a distanced configuration.

The first and second retaining element 3a, 3b of each pair are therefore movable in relative approach, in order to reach the approached position and grasp, in cooperation, a container 200, and in relative distancing, in order to reach the distanced configuration and disengage from the container 200.

In addition, the first and second retaining element 3a, 3b are movable along the conveying path “P” in an approached position, in order to transfer the respective container grasped therebetween along the conveying path “P”.

Therefore, the first and second retaining element 3a, 3b, when in an approached position, are movable along the conveying path “P” and according to the transfer direction “V” in such a way as to keep a container 200 grasped therebetween and to transfer the container 200 along the conveying path “P”.

According to one aspect of the present invention, the apparatus 100 comprises a rest surface 1000, schematically illustrated in FIG. 2, arranged along the conveying path “P” and arranged to extend the feed conveyor 2.

The first and second retaining element 3a, 3b, while performing a transport of a respective container 200, are configured to perform a sliding between the container 200 transported by them and the rest surface 1000.

Alternatively, the first and second retaining element 3a, 3b, while performing a transport of a respective container 200, are configured to keep the container 200 transported by them in an elevated position with respect to the rest surface 1000.

According to one aspect of the present invention, the first and second retaining element 3a, 3b are mounted and movable on respective reciprocally distinct tracks 4, as illustrated in FIGS. 2-8.

Advantageously, the retaining elements 3a, 3b, being arranged on the respective tracks 4, when moved in approach, i.e. when in an approached position, do not interfere with each other, allowing to define a gripping area extending along the conveying path “P” to a variable extent within a wide range of sizes.

Consequently, advantageously, the retaining elements 3a, 3b allow to grasp, when in an approached position, a container 200 of variable sizes, i.e. a container extending to a different extent along the conveying path “P”. Observing the retaining elements 3a, 3b of a single track 4, they are equally spaced along the respective track 4 according to a fixed predefined distance.

With reference to FIGS. 3-8, the tracks 4 are independent and each track 4 is defined by a respective loop conveyor.

In other words, each track 4 comprises a loop conveyor preferably defined by a closed-type mechanical transmission member, such as a conveyor belt, a belt, a chain or another member movable along a respective closed trajectory, preferably moved by means of a respective motorized member “M”, schematically indicated in FIG. 2.

Even more preferably, the motorized member of each track 4 is independently actuatable.

With reference to the attached figures, each track 4 also has a transport portion 4a parallel to the conveying path “P” and the transport portions 4a of the tracks 4 face each other, defining therebetween a conveying channel 40 within which the containers 200 transit.

Therefore, the retaining elements 3a, 3b transit in an approached position, together with the respective container 200 grasped therebetween, along the conveying channel 40.

In other words, each track 4 comprises a transport portion 4a, intended to at least partially define the conveying channel 40, therefore the first and second retaining element 3a, 3b transit in an approached position, together with the respective container 200 grasped therebetween, along the transport portion 4a of the respective track 4.

Preferably, each transport portion 4a has rectilinear development, so as to define a rectilinear extension of the conveying channel 40.

Each track 4 further comprises a return portion 4b, opposite to the transport portion 4a and intended to perform a recirculation of the retaining elements 3a, 3b to and from the transport portion 4a.

Preferably, the return portion 4b is mirrored with respect to the transport portion 4a.

Furthermore, the track 4 comprises a pair of curved portions 4c arranged for the connection of pairs of opposite ends of the transport and return portions 4a, 4b.

Preferably, a first curved portion 4c is arranged at least partially at the pick-up region “A”.

Therefore, the retaining elements 3a, 3b transit along the respective first curved portion 4c at the pick-up region “A” and along the respective transport portion 4a to grasp and transport the container 200.

Preferably, a second curved portion 4c is arranged at least partially at a release region “B”, i.e. at a region distal with respect to the pick-up region “A”.

The retaining elements 3a, 3b transit along the respective second curved portion 4c at the release region “B” to release the transported container 200.

Finally, the retaining elements 3a, 3b transit along the recirculation portion 4b after releasing the container 200 at the release region “B”, to be arranged again at the pick-up region “A”.

In accordance with an embodiment schematically illustrated in FIG. 1, the apparatus 100 comprises two pairs of tracks 4, and the tracks 4 of each pair of tracks 4 face each other at the respective transport portion 4a.

The two pairs of tracks 4 are arranged parallel such that a first pair of tracks 4 is positioned above with respect to a second pair of tracks 4.

Advantageously, such a conformation allows the passage of first transfer equipments 3 along the transport portion 4a of a first pair of tracks 4 simultaneously with a passage of second transfer equipments 3 the return portion 4b of a second pair of tracks 4. Therefore, during a recirculation of the second transfer equipments 3, the first transfer equipments 3 perform a transport of respective containers 200, and vice versa.

Advantageously, the two pairs of tracks 4 allow to decrease the transport times of the containers by means of the apparatus 100.

In detail, the two pairs of tracks 4 are mounted so that when a first pair of tracks 4 is transferring a first group of containers 200 on the plates 7 of the machine (and therefore is positioned at the release region “B”), the second pair of tracks 4 is arranged at the pick-up region “A” to pick up further containers 200 arriving from the feed conveyor 2.

In this way, advantageously, the apparatus 100 makes it possible to convert a continuous motion of the incoming containers 200 (by means of the feed conveyor 2 which moves according to a continuous motion at constant speed) into an alternating motion of the containers exiting the apparatus 200 itself, where by “alternating” is meant groups of containers 200.

With reference to FIGS. 9-11, the first and second retaining element 3a, 3b each comprise a respective base 30, applied to the respective track 4.

According to an embodiment illustrated in the attached figures, the tracks 4 are made in the form of conveyor belts, each constrained to a respective retaining element 3a, 3b in such a way that a movement of the conveyor belt corresponds to a movement of the respective retaining element 3a, 3b.

More in detail, each track 4 comprises a toothed belt, coupled to a respective pair of toothed wheels, and constrained to the respective retaining element 3a, 3b by anchoring means interposed between the retaining element 3a, 3b and the belt. Therefore, the retaining element 3a, 3b is fixed with respect to the respective track 4, and can be moved along the conveying path “P” by means of a movement of the track 4 itself.

In accordance with a further embodiment (not illustrated in the attached figures), the base 30 of each retaining element 3 is applied to the respective track 4, by means of a respective carriage, slidable along the track 4 and preferably magnetically coupled with the respective track 4 in order to be individually movable and controllable along the track 4 itself.

In accordance with one aspect of the present invention, the base 30 is suitable for engaging a side portion of a container 200.

In other words, the base 30 of each retaining element 3a, 3b is suitable for engaging a respective side portion of the container 200 at the approached position, in such a way as to perform a grasping of the container 200 itself.

By “side portion” is meant a portion of the container facing the transport portions 4a of the tracks 4.

Each retaining element 3a, 3b further comprises a tooth 31 transverse to the base 30 and illustrated in FIGS. 9-11.

Preferably, the tooth 31 is arranged at an end portion of the base 30 and is made in the form of an extension of the base 30 itself.

The tooth 31 of the first retaining element 3a is suitable for engaging a front portion of the container 200 and the tooth 31 of the second retaining element 3b is suitable for engaging a rear portion of the container 200.

By “front portion” and “rear portion” are meant portions of the container 200 adjacent to the aforementioned side portions, i.e. portions facing along the conveying path “P”, in more detail by “rear portion” is meant an outer portion of the container 200 facing the feed conveyor 2, while by “front portion” is meant an outer portion of the container 200 opposite to the rear portion of the container 200 itself.

Therefore, when in an approached position, the first and second retaining element 3a, 3b define, by means of the respective tooth 31 and the respective base 30, a housing seat suitable for engaging and retaining the container 200 in at least two points.

Advantageously, thanks to the engagement of side portions of the container 200, made by means of the bases 30 of each retaining element 3a, 3b, and thanks to the engagement of front and rear portion of the container 200 itself, made by means of the teeth 31 of each retaining element 3a, 3b, the apparatus 100 allows a firm grasping of the container 200.

Preferably, the first and second retaining element 3a, 3b each comprise an engagement bearing 32, illustrated in FIGS. 9-11.

In more detail, the engagement bearing 32 is solidly constrained with the base 30 and is suitable for resilient engagement with a container 200, at least along the conveying path “P”.

The term “resilient engagement” means that the bearing 32 is adapted to deform following contact with the container 200 and/or that the bearing 32 comprises a material insert adapted to define a high coefficient of friction with the container 200.

In more detail, each bearing 32 is adapted to engage a respective side portion of the container 200.

Therefore, the bearings 32 of each retaining element 3a, 3b are suitable for engaging and retaining a container 200, when the respective retaining elements 3a, 3b are in an approached position.

Advantageously, the engagement bearing 32 of each retaining element 3a, 3b allows to assist in a firm grasping of the container 200.

According to one aspect of the present invention, and with reference to FIGS. 9-11, the base 30 of each retaining element 3a, 3b is formed by at least one portion 30a extending according to a direction substantially parallel to said conveying path P. The portions 30a of the first and second retaining element (3a, 3b) are configured to remain parallel to each other along said conveying path P, and are configured to come into contact with respective opposite side portions of the container 200 so as to achieve a retention of the container 200 and a simultaneous centring thereof with respect to a central axis of development of said conveying path P (in FIG. 3 the central axis of development coincides with the dash-dot line indicated with the reference “P”). This central axis of development is equally spaced from the side tracks 4 (or from the respective transport portions 4a).

In other words, the portions 30a of the retaining elements 3a, 3b opposite to the container 200 are arranged in a position such as to define a retention of the container 200 itself by coming into direct contact with the side walls of the latter.

As better explained below, the portions 30a, opposite to the container, are adjustable with respect to the container 200 itself so as to be equidistant from the central axis of development of said conveying path.

It should also be noted that the portions 30a of the retaining elements 3a, 3b are fixed, i.e. not movable, with respect to the respective track 4 according to a direction orthogonal to the conveying path P. Obviously, the portions 30a move along the track following the retaining elements 3a, 3b, but they are not movable orthogonally to the direction of the conveying path (they cannot be approached/distanced to/from the track 4).

Furthermore, wherein each portion 30a is fixed to the tooth 31 and angled with respect to the tooth 31 by an angle preferably equal to 90°. Said portion 30a and said tooth 31 are rotatably fixed with respect to the rest of the retaining element 3a, 3b and therefore the tooth 31 always remains in an orthogonal position with respect to the conveying path P and the portion 30a always remains parallel with respect to the conveying path P.

Preferably, the base 30 of each retaining element 3a, 3b is formed by at least two portions 30a that are articulated between one another and mounted on the respective track 4.

Preferably, said portions 30a are hinged to each other at a pair of respective ends.

According to one aspect of the present invention, the two portions 30a comprise a first portion comprising the tooth 31, and a second portion comprising the engagement bearing 32.

Preferably, the tooth 31 is solidly constrained with a free end of said first portion, i.e. at an end that is not articulated with said second portion of the two portions 30a.

Preferably, the bearing 32 is solidly constrained with said second portion of the two portions 30a.

Preferably, the first portion, i.e. the portion 30a solidly constrained with the tooth 31, has a convergent course towards the tooth 31.

Advantageously, the articulated portions 30a define a convex configuration (illustrated in FIGS. 9-11 downstream of the transfer direction “V”) of the respective retaining element 3a, 3b at each curved portion 4c of the respective track 4, suitable for a progressive grasping of the container 200 at the pick-up region “A” and a progressive release of the container 200 at the release region “B”.

According to one aspect of the present invention and with reference to FIG. 2, the apparatus 100 comprises detecting means 5, configured to generate an input signal, identifying that the pick-up region “A” has been reached by a container 200.

In other words, the detecting means 5 is configured to detect a container 200 at the pick-up region “A”.

Preferably, the detecting means 5 comprises a photocell, arranged in proximity to the pick-up region “A”.

Alternatively, the detecting means 5 comprises an optical sensor, arranged in proximity to the pick-up region “A”.

Alternatively, the detecting means 5 comprises a load cell, arranged below with respect to the pick-up region “A” and configured to detect a change in weight, caused by the transit of a container 200, at the pick-up region “A”.

Alternatively, the detecting means 5 is arranged on the single retaining element 3a, 3b, in particular on the tooth, to detect direct contact with the incoming container.

In any case, the detecting means 5 may also comprise a detector (preferably an encoder) mounted at the conveyor belt 2 and configured to detect the actual speed of movement of the conveyor belt 2 in order to synchronize the grip of the container 200 at the pick-up region “A”.

According to one aspect of the present invention, the apparatus 100 further comprises a control unit 6, schematically illustrated in FIG. 2, operationally connected to the transfer equipment 3 and to the detecting means 5 to receive said input signal and to drive individually the retaining elements 3a, 3b of the transfer equipment 3 in function of the input signal itself.

Preferably, the control unit 6 is operationally connected with the motorized member “M”.

Advantageously, the control unit 6 performs a movement of the retaining elements 3a, 3b at a transit of a container 200 within the pick-up region “A”.

In other words, the control unit 6 is configured to drive the approached position, suitable for grasping a container 200 between the retaining elements 3a, 3b, in function of the input signal, i.e. in the event of the presence of a container 200 at the pick-up region “A”.

Advantageously, moreover, the control unit 6, by individually driving the retaining elements 3a, 3b, allows a definition of a plurality of approached positions of the retaining elements 3a, 3b, compatible with a respective plurality of containers having different widths. In other words, the control unit 6 is configured to individually drive the retaining elements 3a, 3b in such a way as to selectively position them at a predetermined distance in function of a format of the container 200 which is preselected and which is the same for each group of containers 200.

In accordance with an embodiment of the present invention, the control unit 6 is configured to command a positioning of the first retaining element 3a at the pick-up region “A” such that a container 200 impacts against the tooth 31 of the first retaining element 3a when at the pick-up region “A”.

In accordance with the aforementioned embodiment, the control unit 6 is also configured to command a movement of the first and second retaining element 3a 3b along the respective tracks 4 in function of the aforementioned input signal. Therefore, the control unit 6 is configured to synchronize a movement of the first and second retaining element 3a and 3b with a kinematic condition of the container 200.

The control unit 6 is further configured to move the first retaining element 3a of the transfer equipment 3 in function of the input signal and to move the second retaining element 3b of the transfer equipment 3 in function of additional information on the format of the container 200, or on an activation signal corresponding to a detecting a passage of the rear edge of the container 200.

“Rear edge” means an external profile of the container facing the feed conveyor 2.

In other words, the control unit 6 is configured to arrange the first and second retaining element 3a, 3b in an approached position at a predetermined reciprocal distance, in function of a format of the container 200, i.e. in function of an extension along the conveying path “P” of the container 200. Therefore, the control unit 6 is configured to drive a plurality of approached positions of the retaining elements 3a, 3b, compatible with a respective plurality of containers having different widths.

In other words, the control unit is programmed to arrange the retaining elements 3a of one track 4 offset with respect to the retaining elements 3b of the other track 4 so as to define a grip on a container 200 interposed therebetween.

Preferably, the apparatus 100 comprises a user interface (not illustrated in the attached figures) operationally connected with the control unit 6 and configured to allow a manual entry of the format of the container 200, i.e. of the additional information on the format of the container 200.

In accordance with one embodiment of the present invention, the detecting means 5 is configured to detect a passage of the rear edge of the container 200, thus detecting the instant at which it is appropriate to activate the movement of the rear retaining element 3b.

In accordance with one aspect of the present invention, the feed conveyor 2 is configured to feed to the pick-up region “A” a succession of containers 200, arranged at a reciprocal non-uniform distance, as illustrated in FIGS. 2-8.

In other words, the feed conveyor 2 is configured to progressively feed a succession of containers 200, each container 200 arranging the succession of containers 200 at the pick-up region “A”.

Therefore, the feed conveyor 2 is configured to feed one container 200 at a time at the pick-up region “A”.

The apparatus 100 also comprises a plurality of transfer equipments 3, arranged in succession along the tracks 4, to perform a picking and transfer of a batch 300, comprising a predetermined number of containers 200, with a predefined reciprocal spacing along the conveying path “P”.

In other words, each transfer equipment 3 is configured to pick up from the pick-up region “A” a respective container 200 and the plurality of equipments 3 is configured to pick up, and consequently define, the batch 300.

Advantageously, the apparatus 100 allows a realization of a batch 300 comprising containers 200 in number and with predetermined spacing, starting from a supply of containers 200 according to a random order.

According to one embodiment illustrated in the attached figures, the tracks 4 are made in the form of conveyor belts, each constrained to respective retaining elements 3a, 3b by anchoring means interposed between the retaining element 3a, 3b and the belt. Therefore, the retaining elements 3a, 3b are constrained to the respective belt at fixed and predetermined positions and a spacing between the positions of the retaining elements 3a, 3b corresponds to a spacing between the containers of the batch 300 picked up by the retaining elements 3a, 3b.

In accordance with a further embodiment (not illustrated in the attached figures), the retaining elements 3a, 3b are applied to the respective track 4 by means of a corresponding carriage, slidable along the track 4 and preferably magnetically coupled with the respective track 4. Therefore, the control unit 6 is configured to maintain the retaining elements 3a, 3b at a relative spacing, predetermined along the respective track 4 and corresponding to a spacing between the containers of the batch 300 picked up by the retaining elements 3a, 3b.

The control unit 6 is preferably configured to drive in succession each transfer equipment 3 of the plurality of retaining equipments 3 in function of successive input signals, and each input signal identifies that the pick-up region “A” has been reached by a respective container 200.

Therefore, the feed conveyor 2 is configured to feed one container 200 at a time at the pick-up region “A”, and the detecting means 5 is configured to generate successive input signals, identifying successive containers 200 fed to the pick-up region “A”.

In more detail, the control unit 6 is configured to achieve progressive approached positions and progressive distanced positions of the first and second retaining elements 3a, 3b of each transfer equipment 3 of the plurality of retaining equipments 3.

In other words, the control unit 6 independently drives each transfer equipment 3 of the plurality of transfer equipments 3, so as to grasp a respective container 200.

According to the embodiment illustrated in the attached figures, wherein the tracks 4 are made in the form of conveyor belts or belts, each constrained to a respective plurality of retaining elements 3a, 3b by anchoring means interposed between each retaining element 3a, 3b and the respective belt, the retaining elements 3a, 3b are simultaneously moved at a movement of the respective conveyor belt or belt. Therefore, the control unit 6 drives successive movement of the belts, therefore successive movements of the plurality of transfer equipments 3, at successive input signals, while the spacing between the retaining equipments 3 is unchangeable and predetermined, entrusting the control unit 6 with the function of synchronising the first available container 200 with the first free transfer equipment 3 from time to time.

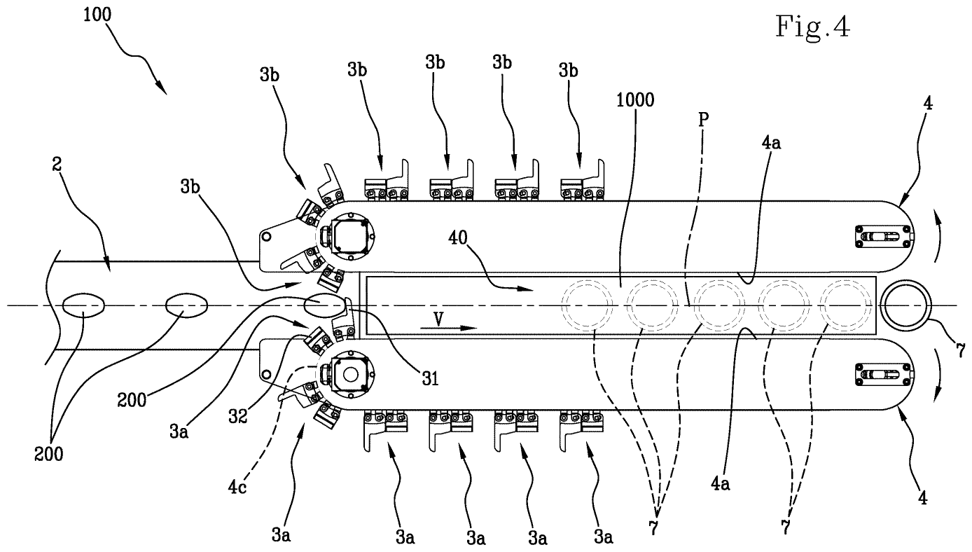

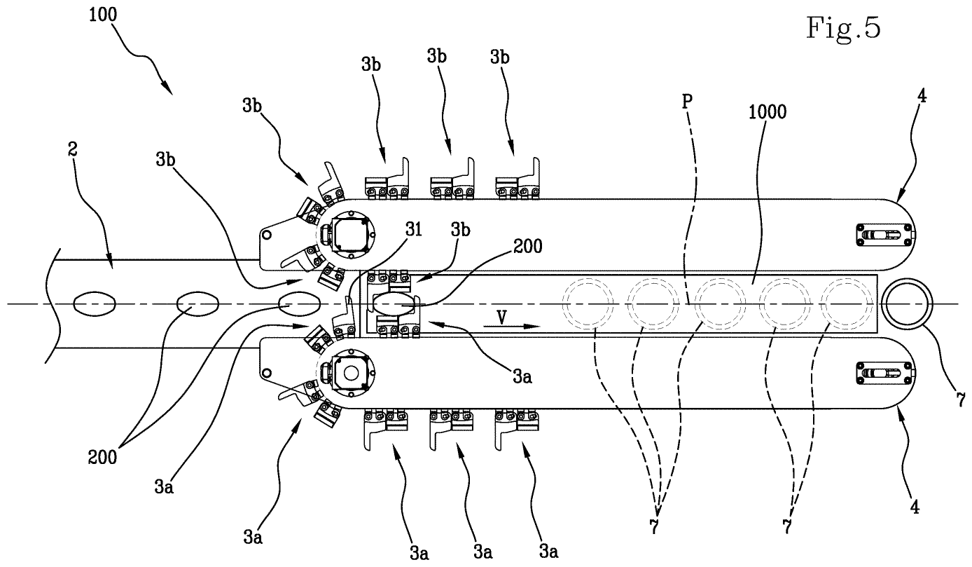

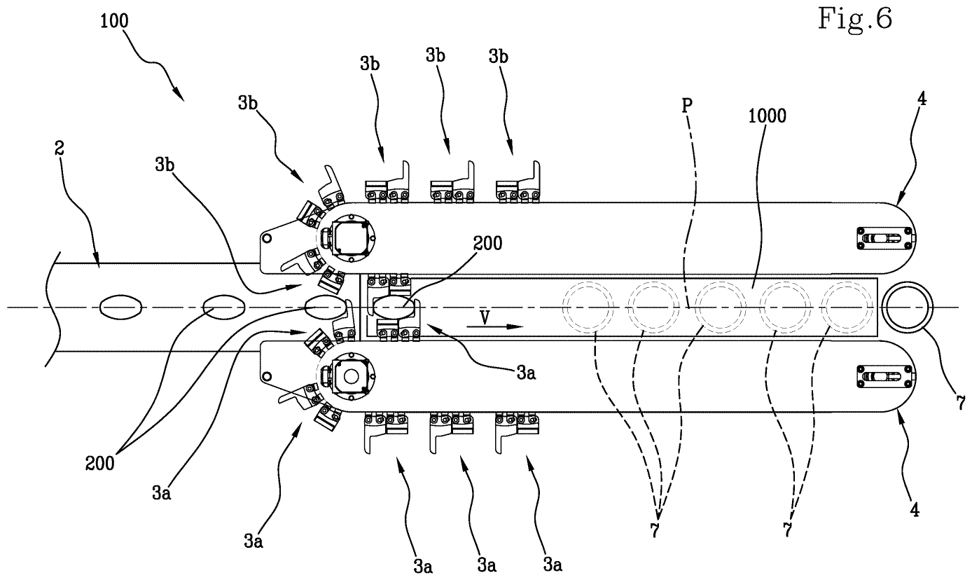

By way of example, FIG. 4 and FIG. 5 show a first movement of a first transfer equipment 3 to pick up a first container 200, while FIG. 6-8 show movements subsequent to the first movement of further transfer equipments 3, to pick up respective further containers 200.

In other words, the control unit 6 drives successive movements of the plurality of transfer equipments 3, at the aforementioned input signal, and successive stops of the plurality of transfer equipments 3, in the absence of the mentioned input signal.

Preferably, once all the containers 200 defining the batch 300 have been hung, i.e. when all the retaining elements 3a, 3b of the transfer equipments 3 are in an approached position, the control unit 6 drives a simultaneous transfer of the grasped containers 200.

According to one aspect of the present invention, the apparatus 100 comprises a plurality of plates 7 arranged in succession and illustrated in FIGS. 2-8.

The plates 7 are arranged at a lower vertical level with respect to a vertical level of the feed conveyor 2 and of the rest surface 1000, in more detail, at least a portion of the plurality of plates is arranged below the rest surface 1000, as schematically illustrated in FIGS. 2-8.

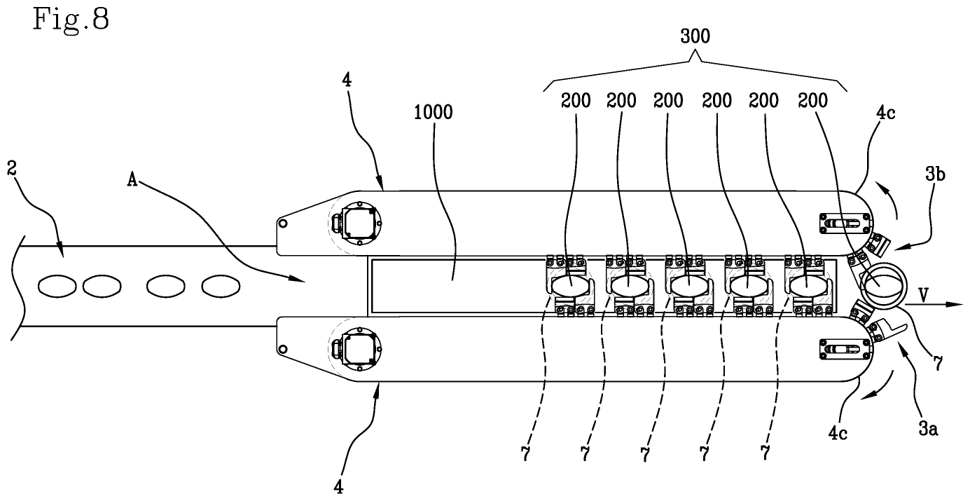

The plates 7 are movable between a gripping position, in which each plate 7 receives supportingly a respective container 200 released by a respective transfer equipment 3 in the release region “B”, and a release position, in which each plate 7 transfers the respective container 200 to a further process unit (not illustrated in the attached figures), as schematically illustrated in FIGS. 2 and 8.

According to one aspect of the present invention, the control unit 6 is configured to drive a movement of the plates 7, in such a way as to allow a release of each container 200 on a respective plate 7 and in such a way as to transport each released container 200 from the release region “B” to the further process unit.

Preferably, the control unit 6 is configured to synchronize a speed of each plate 7 to a speed of each container 200 released at the release region “B”.

According to one aspect of the present invention, the speed of each container 200 released at the release region “B” may be equal to, greater than, or lower than a speed of each container at the pick-up region “A”. In other words, the control unit 6 is configured to perform an acceleration or a deceleration of the containers 200 transported by each transfer equipment 3 along the conveying path “P”. The plates 7 also have a reciprocal distance corresponding to the reciprocal distance between the retaining equipments 3 in the release region “B”.

According to one embodiment illustrated in the attached figures, the tracks 4 are made in the form of conveyor belts, and a respective plurality of retaining elements 3a, 3b is constrained to a respective belt with a predetermined and fixed spacing. Therefore, the plates 7 have a reciprocal distance corresponding to said predetermined and fixed spacing.

The plates 7 are adapted to receive the batch 300 supportingly, as well as to transport the batch 300 as far as a further working unit.

Preferably, the plates 7 are rotatable in such a way as to impose a rotation of a respective container 200 about an axis of development thereof.

Advantageously, a rotation of the plates 7 makes it possible to carry out a labelling of the container 200 transported by them.

Preferably, the apparatus 100 further comprises positioning members (not illustrated in the attached figures), configured to engage the container 200 in an upper portion thereof, in such a way as to press the container 200 itself against a corresponding plate 7, advantageously providing greater stability during a transport of the container 200 itself by the plate 7.

Advantageously, the plates 7 allow achieving a simultaneous transfer of the containers 200 defining the batch 300, allowing a decrease in the transfer times of the batch 300 itself.

In accordance with one aspect of the present invention and with reference to FIG. 1, the apparatus 100 comprises vertical adjusting means 8, configured to set the reciprocal vertical positioning between the retaining elements 3a, 3b and the feed conveyor 2.

In other words, the vertical adjusting means 8 is configured to move the tracks 4, to which the retaining elements 3a, 3b are solidly constrained, along a vertical direction and away from or towards the feed conveyor 2.

Preferably, the frame 1 comprises a fixed base “C” and a movable portion supported by the base “C”.

In more detail, the movable portion supports the tracks 4 and the vertical adjusting means 8 comprises a worm mechanism connected between the base “C” and the movable portion supported by it, in such a way that an actuation of the mechanism corresponds to a movement of the movable portion and therefore of the tracks 4 supported by it.

Advantageously, the vertical adjusting means 8 allows to adapt the apparatus 100 to formats of containers having different heights.

The term “height” refers to an extension of the container 200 along a vertical direction, i.e. along an axis around which the container 200 itself develops.

In accordance with one aspect of the present invention and with reference to FIG. 1, the apparatus 100 comprises horizontal adjusting means 9, configured to set the width of the conveying channel 40 by reciprocal approaching or distancing between the tracks 4.

“Width” means an extension of the conveying channel along a transverse direction with respect to the conveying path “P”.

Preferably, the horizontal adjusting means 9 comprises a worm mechanism connected to each track 4, such that an actuation of the mechanism corresponds to a movement of the respective track 4.

Preferably, the adjusting means 4 is independent for each track 4, advantageously allowing each track 4 to be moved independently.

In more detail, the horizontal adjusting means 9 is arranged for connection between said movable portion of the frame 1 and the horizontal adjusting means 9.

Advantageously, the horizontal adjusting means 9 allows the width of the conveying channel 40 to be increased and decreased, allowing the machine to be adapted to containers having variable sizes along a direction transverse to the conveying path “P”.

The present invention makes available a method for the controlled movement of containers 200.

Advantageously, the method is realizable by means of the above apparatus 100.

The method, performed by means of the apparatus 100, is schematically illustrated in FIGS. 2-8.

The method comprises a step of feeding at least one container 200 to a pick-up region “A”.

The method further comprises a step of picking up the at least one container 200 from the pick-up region “A”.

The method also comprises a step of transferring the at least one container 200 away from the pick-up region “A” along a conveying path “P”.

In more detail, the step of picking up the container 200 from the pick-up region “A” is performed by means of a first and a second retaining element 3a, 3b, preferably comprised within the apparatus 100, independently movable along respective closed paths, preferably defined by the tracks 4 of the apparatus 100.

The pick-up step comprises reciprocally moving the retaining elements 3a, 3b to define at least the approached position, suitable for grasping the container 200 therebetween.

The method comprises grasping the container 200 at a front portion thereof and at a rear portion thereof.

In more detail, the pick-up step carried out by means of the apparatus 100, comprises positioning the first retaining element 3a at the pick-up region “A” and feeding a container 200 by means of the feed conveyor 2 as far as the pick-up region “A”, as schematically illustrated in FIG. 3. Subsequently, the pick-up step comprises actuating the first retaining element 3a, moving it along the respective track 4, at an interception of the first retaining element 3a by a front portion of the fed container 200, as schematically illustrated in FIG. 4.

According to one aspect of the present invention, the step of picking up the container 200 from the pick-up region “A” is performed by detecting, by means of a sensor, that the pick-up region “A” has been reached by a container 200. In other words, the pick-up step comprises a detection step, i.e. a step of detecting, by means of the sensor, that the pick-up region “A” has been reached by a container 200 in such a way as to command an actuation of the first retaining element 3a.

In the apparatus 100, the sensor is realized in the form of the detecting means 5.

Then, after moving the first retaining element 3a, the method preferably provides for generating an input signal, representing the that the pick-up region “A” has been reached by a container 200, by means of the sensor, so as to activate, in function of the input signal itself, the first retaining element 3a.

Therefore, the pick-up step is carried out in function of the signal generated by said sensor.

According to one aspect of the present invention, the step of picking up the container 200 is performed at least partially during an advancement of the container 200 along the conveying path “P”. Therefore, an actuation of the first retaining element 3a is simultaneous with an advancement along the conveying path “P” of the container 200.

The pick-up step also comprises actuating the second retaining element 3b, moving it along the respective track 4, to position the first and second retaining element 3a, 3b in an approached position in such a way as to grasp the fed container 200, as schematically illustrated in FIG. 5.

The method provides for moving the second retaining element 3b in function of additional information on the format of the container 200, or of an activation signal corresponding to detecting a passage of the rear edge of the container 200.

In other words, the pick-up step comprises, upon actuation of the second retaining element 3b, generating said additional information by means of the sensor, detecting a rear edge of the container, or setting said additional information by means of a user interface.

According to one aspect of the present invention, the step of picking up the container 200 comprises a synchronization of the second retaining element 3b to a speed of the container 200.

In the apparatus 100, the control unit 6 is operationally connected to the second retaining element 3b and is configured to synchronize a movement of the second retaining element 3b to a speed of the container 200.

Preferably, said synchronization comprises having the container 200 followed by the second retaining element 3b at a speed greater than the advancement speed of the container 200.

In other words, the step of picking up the container 200 comprises a step of detecting a feed speed of the container 200 at the pick-up region “A”, and a successive step of moving the second retaining element 3b at a speed greater than the detected feeding speed, in such a way as to achieve that the fed container 200 is being followed, advantageously ensuring a firm grasping thereof. In the apparatus 100, the speed detection is performed by the detecting means 5.

Alternatively or in addition, the synchronization of the second retaining element 3b comprises a step of detecting a speed of the container 200 at the pick-up region “A”, preferably by means of a detector (encoder) mounted on the movement means (motor) of the conveyor belt 2, and a successive step of moving the second retaining element 3b at a speed equal to the detected speed, in such a way as to grasp the fed container 200. In the apparatus 100, the speed detection is performed by the detecting means 5.

The step of transferring the container 200 comprises moving it along the conveying path “P”, and in a direct transfer direction away from the pick-up region “A” and illustrated by means of an arrow “V” in the attached figures. In the apparatus 100, the step of transferring the container 200 comprises a step of moving the container 200 along the rest surface 1000, while keeping the container in an elevated position with respect to the rest surface 1000, or achieving a sliding between the transported container 200 and the rest surface 1000.

Alternatively, the rest surface 1000 could not be present and therefore the container is kept in a suspended position until it is released at the plates 7.

In more detail, the step of transferring the container 200 comprises moving the retaining elements 3a, 3b along the conveying path “P” keeping them in an approached position, in such a way as to transfer the container 200 (grasped during the pick-up step) away from the pick-up region “A”.

According to one aspect of the present invention, the transfer step comprises a step of increasing or decreasing a speed of a container 200 during the transfer thereof. In the apparatus 100, the control unit 6 is configured to realize such an increase or decrease of the speed of a container 200 during the transfer thereof.

The step of transferring the container 200 further comprises moving the retaining elements 3a, 3b to a distanced position to disengage the container therefrom, at a release region “B”, distal with respect to the pick-up region “A”.

According to one aspect of the present invention, the step of feeding at least one container 200 to the pick-up region “A” is performed by feeding to the pick-up region “A” a succession of containers 200 having a reciprocal distance that is preferably random within a predetermined interval as schematically illustrated in FIGS. 3-8.

According to one aspect of the present invention, the pick-up step is carried out by sequentially picking up the containers 200 from the succession and advancing the containers 200 along the identical and predetermined conveying path “P” of the containers 200.

In the apparatus 100, this operation is performed by means of a plurality of transfer equipments 3.

According to one aspect of the present invention, the picked-up containers 200 wait along the conveying path “P” until a predetermined number of picked-up containers 200 is reached.

In other words, the method provides for a transit of at least one first container 200 already picked up, and therefore grasped by a respective transfer equipment 3, along the conveying path “P” while a second container 200 is being picked up.

In more detail, the method provides for arranging a first retaining element 3a of a first transfer equipment 3 at the pick-up region “A” and for maintaining the first retaining element 3a of the first transfer equipment 3 at the pick-up region “A” while a first container 200 is being fed to the pick-up region “A”, as schematically illustrated in FIG. 3.

The method comprises, subsequently to an engagement between the first fed container 200 and the first retaining element 3a at the pick-up region “A” (schematically illustrated in FIG. 4), actuating the first retaining element 3a.

Preferably, said actuation is carried out on the basis of said input signal.

The method comprises a movement of a second retaining element 3b of the first transfer equipment 3 in such a way as to achieve a grasping of the first fed container 100, as schematically illustrated in FIG. 5.

Preferably, the movement of the second retaining element 3b is carried out in function of said additional information.

The method comprises, subsequently to the step of grasping the first container 200, a movement of the same, performed by means of the first and second retaining element 3a of the first transfer equipment 3, along the conveying path “P”.

According to one embodiment illustrated in the attached figures, the tracks 4 are made in the form of conveyor belts, each constrained to respective retaining elements 3a, 3b by anchoring means interposed between the retaining element 3a, 3b and the belt. Therefore, the retaining elements 3a, 3b are constrained to the respective belt at fixed and predetermined positions, therefore the retaining elements 3a, 3b are movable along the respective tracks 4 simultaneously.

In accordance with this embodiment, the movement of the first container 200, grasped by means of the retaining elements 3a, 3b of the first transfer equipment 3, is performed “in steps”.

Therefore, once the first container 200 has been grasped, the method provides for a first jerk of the first transfer equipment 3 along the conveying path “P”, i.e. a first movement of the first transfer equipment 3 until a first retaining element 3a of a second transfer equipment 3, subsequent to the first transfer equipment 3, is arranged at the pick-up region “A”, as schematically illustrated in FIG. 6.

It is therefore provided for a stop of the movement of the transfer equipments 3 until a second container 200 is fed at the pick-up region “A”.

In the event that the containers arrive from the belt 2 at a constant distance and similar to that between two successive retaining elements 3a or 3b, the movement of the respective track 4 could be continuous and done at the same speed as the belt 2.

Upon reaching the second container 200 at the pick-up region “A”, the method provides for grasping and transporting it, carried out according to the same steps as the first container.

In accordance with a further embodiment (not illustrated in the attached figures), the retaining elements 3a, 3b are applied to the respective track 4 by means of a corresponding carriage, slidable along the track 4 and preferably magnetically coupled with the respective track 4.

In accordance with the further embodiment, the method provides for a movement of each container 200, grasped by means of the retaining elements 3a, 3b of each transfer equipment 3, it continues, in other words, the method provides for grasping a first container 200 by means of a first transfer equipment 3 and transferring the same along the conveying path “P”, simultaneously or subsequently, the method provides for grasping a second container 200 by means of a second transfer equipment 3, subsequent to the first transfer equipment 3, and transferring the same along the conveying path “P”.

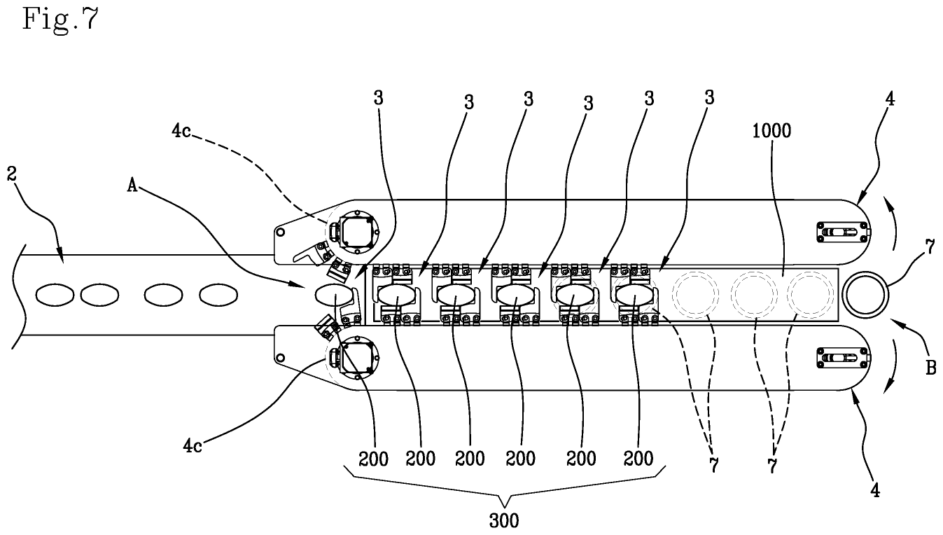

The method provides for further subsequent pick-up, grasping and transferring steps, for picking up, grasping and transferring further containers 200, subsequent to the second container 200, in accordance with the same steps of the first and second containers, as schematically illustrated in FIG. 7.

According to one aspect of the present invention, after the predetermined number of picked-up containers 200 is reached, the containers 200 are released. In other words, following the predetermined number of picked-up containers 200 being reached, the method comprises a step of transporting and then releasing the picked-up containers 200.

Preferably the release of the containers 200 takes place in succession (as each transfer equipment 3 arrives at the release region “B”) and is performed by the retaining elements 3a, 3b in a distanced position.

When the method is carried out by means of the apparatus 100, it comprises a step of releasing the containers resting on respective plates 7 and at a release region “B”, as schematically illustrated in FIG. 8.

The plates 7 preferably have the same reciprocal distance assumed by the containers along the conveying path “P”.

Advantageously, the apparatus 100 is capable of achieving the intended purposes.

In particular, the apparatus 100 comprises transfer equipments 3 that are versatile, i.e. compatible with containers 200 of varying sizes.

Furthermore, the apparatus 100 is efficient, i.e. capable of determining a decrease in the time required to process a plurality of containers 200.

Finally, the machine is able to operate on batches of containers (for example a batch having a number of containers from 2 to 10) that arrive with irregular or random spacings by dispensing a succession of containers with fixed and predetermined spacing.

In particular, the present invention achieves its intended purposes by allowing:
to convey container formats with different shapes and sizes without the need to change any mechanical details. Thanks to the three degrees of freedom (height, width, distance between the retaining elements 3a, 3b) and to the shape of the gripping elements, it is possible to achieve this adaptation;
to receive containers with continuous cycle, thus transforming the continuous flow of the upstream belt into an alternating flow of processing in the machine through the plates.
to adapt the pitch between one bottle and the other on the belt at which bottles can arrive at different reciprocal distances;
to adapt the speed of exit of the bottles from the transfer equipment with respect to the working speed of the machine.

1-22. (canceled)

23. An apparatus for a controlled movement of containers, the apparatus comprising:
a feed conveyor, configured to feed at least one container to a pick-up region;
at least one transfer equipment, configured to pick up the container from the pick-up region and to perform a transfer of the container along a conveying path;
wherein the transfer equipment comprises a first and a second retaining element, which are reciprocally movable along the conveying path to define at least one approached position, which is suitable for grasping the container therebetween, and a distanced position, which is suitable for disengagement from said container;
wherein the first and the second retaining element of said at least one transfer equipment are mounted and movable on respective independent tracks and wherein each track is defined by a respective loop conveyor;
wherein said first and said second retaining element each comprise a respective base, applied to the respective track and configured for engaging a side portion of the container, and a tooth transverse to the base, wherein the tooth of the first retaining element is configured for engaging a front portion of the container and wherein the tooth of the second retaining element is configured for engaging a rear portion of the container;
wherein the base of each retaining element comprises at least one portion extending according to a direction substantially parallel to said conveying path;
the portions of said first and said second retaining element being configured to remain parallel to each other along said conveying path and being configured to come into contact with respective opposite side portions of the container so as to achieve a retention of said container and a centring thereof with respect to a central axis of development of said conveying path,
wherein said portions are fixed with respect to the respective track according to a direction orthogonal to the conveying path.

24. The apparatus according to claim 23, wherein each portion is fixed and angled with respect to the tooth; said portion and said tooth are rotatably fixed with respect to a rest of the retaining element.

25. The apparatus according to claim 23, wherein each of said tracks has a transport portion parallel to said conveying path and wherein the transport portions of the tracks face one another, defining between them a conveying channel within which said containers transit.

26. The apparatus according to claim 23, wherein said first and said second retaining element each comprise an engagement bearing, which is solidly constrained to said base and suitable for resilient engagement with a container at least along said conveying path.

27. The apparatus according to claim 26, wherein the base of each retaining element is formed by at least two portions that are articulated between one another and mounted on the respective track, the tooth being preferably solidly constrained to one of the two portions and the engagement bearing being arranged on the other portion.

28. The apparatus according to claim 23, further comprising:
detecting means, configured to generate an input signal, identifying that the pick-up region has been reached by a container;
a control unit, operationally connected to said transfer equipment and to the detecting means to receive said input signal and to drive individually the retaining elements of the transfer equipment in function of said input signal.

29. The apparatus according to claim 28, wherein said control unit is configured to move the first retaining element of the transfer equipment in function of the input signal and to move the second retaining element of the transfer equipment in function of additional information on a format of the container or of an activation signal corresponding to detecting a passage of a rear edge of the container.

30. The apparatus according to claim 23, wherein:
said feed conveyor is configured to feed to the pick-up region a succession of containers, arranged at a reciprocal non-uniform spacing;
said apparatus comprises a plurality of the transfer equipment, arranged in succession along the tracks, to perform a transfer of a batch, comprising a predetermined number of containers, with predetermined reciprocal spacing along the conveying path.

31. The apparatus according to claim 28, wherein said control unit is configured to drive in succession each transfer equipment of a plurality of the transfer equipment in function of successive input signals, wherein each input signal identifies that the pick-up region has been reached by a respective container, said control unit achieving progressive approached positions and progressive distanced positions of the first and second retaining element of each transfer equipment of said plurality of the transfer equipment.

32. The apparatus according to claim 30, comprising a plurality of plates arranged in succession and movable between a gripping position, in which each plate supportingly receives a respective container released by a respective transfer equipment in a release region, and a release position, in which each plate transfers the respective container to a further process unit, said plates having a reciprocal distance, in the gripping position, corresponding to the reciprocal distance between the plurality of the transfer equipment in the release region.

33. The apparatus according to claim 23, comprising vertical adjusting means, configured to set a reciprocal vertical positioning between the retaining elements and the feed conveyor.

34. The apparatus according to claim 23 characterized in that the portions are adjustable with respect to the container so as to be equidistant from the central axis of development of said conveying path.

35. The apparatus according to claim 23, comprising horizontal adjusting means, configured to set a width of a conveying channel by reciprocal approaching or distancing between said tracks.

36. The apparatus according to claim 23, wherein said retaining elements are equally spaced from each other along the respective track according to a fixed predefined distance.

37. The apparatus according to claim 23, wherein said loop conveyor is defined by a closed-type mechanical transmission member, preferably a belt or chain.

38. The apparatus according to claim 37, wherein a control unit is programmed to arrange the retaining elements of one track offset with respect to the retaining elements of the other track so as to define a grip on a container interposed between them.

39. A method for the controlled movement of containers by means of an apparatus according to claim 23, the method comprising steps of:
feeding at least one container to a pick-up region;
picking up the at least one container from the pick-up region;
transferring the at least one container away from the pick-up region along a conveying path;
wherein the step of picking up the container from the pick-up region is performed by a first and a second retaining element that are movable independently along respective closed paths defined by respective tracks, said retaining elements being moved reciprocally during the step of picking up the container to define at least one approached position, which is suitable for grasping therebetween the container, and a distanced position, that is configured for disengaging from said container, the first retaining element grasping the container at a front portion relative to said conveying path and the second retaining element grasping the container at a rear portion.

40. The method according to claim 39, wherein said step of picking up the container from the pick-up region is performed by means of one or more sensors detecting that the pick-up region has been reached by a container and, on a basis of a signal generated by said sensor, actuating said retaining elements to grasp the container.

41. The method according to claim 39, wherein said step of picking up the container is performed at least partially during an advancement of the container along the conveying path, in particular by having the container followed by the second retaining element at a speed greater than the advancement speed of the container.

42. The method according to claim 39, wherein the step of feeding at least one container to the pick-up region is performed by feeding to the pick-up region a succession of containers having a reciprocal distance that is preferably random within a predetermined interval, and wherein the pick-up step is actuated by picking up in sequence the containers of the succession and by advancing the containers along the conveying path by setting an identical and predetermined reciprocal distance.

43. The method according to claim 42, wherein the picked-up containers wait along the conveying path until a predetermined number of picked-up containers is reached and, after said predetermined number of picked-up containers is reached, the containers are released in succession by the retaining elements to respective plates at a release region, said plates having, at least at the release region, preferably the reciprocal distance assumed by the containers along the conveying path.
